(19) United States
(12) Patent Application Publication
(10) Pub. No.: US 2019/0374861 A1
(43) Pub. Date: Dec. 12, 2019

(54) BASEBALL ANALYSIS SYSTEM AND METHOD FOR FACILITATING ACCESS TO BASEBALL INFORMATION

(71) Applicant: Paul Goodwin, Newhall, CA (US)

(72) Inventor: Paul Goodwin, Newhall, CA (US)

(21) Appl. No.: 16/436,250

(22) Filed: Jun. 10, 2019

Related U.S. Application Data
(60) Provisional application No. 62/684,171, filed on Jun. 12, 2018.

(51) Int. Cl. A63F 13/828; G06F 16/22; G06F 16/2458; A63F 13/812; A63F 13/65

(52) U.S. Cl. CPC A63F 13/828; G06F 16/22; G06F 16/2462; A63F 2300/8052; A63F 13/65; A63F 2300/8011; A63F 13/812

(57) ABSTRACT

A baseball analysis system and method; the system includes a software application downloadable to an electronic-device for calculating and analyzing statistics from a professional baseball player and team. The baseball analysis system includes at least one server having a processor and a memory including a database storing a plurality of baseball-player-related-data including runs batted in, plate appearances, and earned run average(s). The memory further includes computer readable instructions executable by the processor, and the software application downloadable to an electronic-device. A user may input a request into the software application and the software application then determines an output related to the input via the software application. The output is displayed on the electronic-device and may include useful information as related to baseball players from past to present.

### CROSS REFERENCE TO RELATED APPLICATION

The present application is related to and claims priority to U.S. Provisional Patent Application No. 62/684,171 filed Jun. 12, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of mobile applications and more specifically relates to a sports statistics and coaching game mobile application.

### 2. Description of Related Art

Many individuals enjoy playing baseball and being baseball game spectators and fans. Professional baseball players are inducted into a Hall of Fame after extraordinary performances throughout their careers; however, despite performing well, winning championships, etc., some baseball players are left out of the Hall of Fame via a voting committee. Statistics are commonly used by baseball enthusiasts to make attributions as to how much a player contributed to his team throughout his career. Players are judged by how well they did against the opposition at the current year but not as to other years. A suitable solution is desired.

U.S. Pub. No. 2009/0089838 to Angelo J. Pino, Jr. relates to a template based system, device and method for providing interactive content. The described template based system, device and method for providing interactive content comes with broadcast programming. In one embodiment, the method includes storing a plurality of templates for presenting interactive content in a memory, receiving a request for interactive content channel from a viewer, receiving interactive content data associated with the requested interactive content channel, receiving information for selecting a template for displaying the interactive content data, retrieving a template from memory based on the information for selecting a template; populating the retrieved template with the interactive content data to provide an interactive content display; and presenting the interactive content display to the viewer concurrently with the broadcast program. Each broadcast program may have multiple associated interactive content channels and some interactive content channels may be available for display with multiple broadcast programs.

### BRIEF SUMMARY OF THE INVENTION

In view of the foregoing disadvantages inherent in the known mobile applications art, the present disclosure provides a novel baseball analysis system and method for facilitating access to baseball information. The general purpose of the present disclosure, which will be described subsequently in greater detail, is to provide a software application designed as a statistical analysis game for baseball enthusiasts.

A baseball analysis system and method are disclosed herein. The system including a software application downloadable to an electronic-device for calculating and analyzing statistics from a professional baseball player and team. The baseball analysis system includes at least one server having a processor and a memory including a database storing a plurality of baseball-player-related-data. The memory further includes computer readable instructions executable by the processor, and the software application downloadable to an electronic-device. A user may input a request into the software application and the software application then determines an output related to the input via the software application. The output is displayed on the electronic-device and may include useful information as related to baseball players from past to present.

More specifically, the present invention provides users with a smartphone application comprising of a baseball game designed to grade players and teams from any era in professional baseball history. The software application pulls information from a database configured to store information regarding runs, RBIs, plate appearances, ERA, and numerous other baseball statistics on any professional baseball team existing from 1871 and on. It allows baseball enthusiasts to have fun in identifying how historical players would have competed with current Major League Baseball players in the present era. The software offers a more accurate method for enthusiasts and historians to identify the absolute greatest baseball players of all-time by determining how many home runs, hits, etc. a player would have, had he played in a different era. The present invention enables players to manage their own teams and players.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a baseball analysis system and method for facilitating access to baseball information, constructed and operative according to the teachings of the present disclosure.

FIG. 1 is a screen view of the baseball analysis system and method during an ‘in-use’ condition, according to an embodiment of the disclosure.

FIG. 2 is a screen view of the baseball analysis system and method of FIG. 1, according to an embodiment of the present disclosure.

FIG. 3 is a screen view of the baseball analysis system and method of FIG. 1, according to an embodiment of the present disclosure.

FIG. 4 is an ‘in use’ view of the baseball analysis system and method of FIG. 1, according to an embodiment of the present disclosure.

FIG. 5 is flowchart illustrating the method of use for facilitating access to baseball information using the baseball analysis system.

The various embodiments of the present invention will hereinafter be described in conjunction with the appended drawings, wherein like designations denote like elements.

### DETAILED DESCRIPTION

As discussed above, embodiments of the present disclosure relate to a mobile application and more particularly to a baseball analysis system and method for facilitating access to baseball information as used to improve the statistical analysis of baseball players provided as a game through a mobile application.

Generally, baseball analysis system and method includes a software application designed as a statistical analysis game for baseball enthusiasts. The game is capable of calculating and analyzing statistics from any professional baseball player and team from 1871 and on. The game is designed to compare and match statistics from different eras and enable users to determine how well a player or team would have performed in a different time/era. Each player has an All-Time Points (ATP) rating for easy overall comparison. There are numerous other statistics taken into account, each of which can be found in a database connected to the software application.

The software application is intended to pull information from the database and make comparisons between numerous players, teams, stadiums, etc. A spinner mechanism within the game can be used to select year, league, home team, visiting team, and stadium. This enables users to play two teams in a year, league, and stadium neither played in. Games can be played during different time periods (e.g., the first inning is played in 1920, the second in 1930, the third in 1940, and so on). The game is intended to balance the field of professional baseball players and teams and make comparisons in order to determine who could, or should, be considered the greatest players/teams of all time.

The primary method of adjusting player statistics is based on population, demographic breakdown, and height breakdown using only the top half of the players in any given statistic in preferred embodiments.

In regard to the population effect, as an example, take USA White male population from ages 20-35. Assume season B is twice as large as season A. Batters used in the survey must have ranked in the top 8 (number of starting players, 9 if the Designated Hitter was used), times the number of teams, in at-bats for that league. If a league had 10 teams, take 8×10=80 for the survey. Then, divide that by 2 (=40), this produces batters that were in the top half in batting average, (i.e., they were paid to hit, not just field). On average, we can assume the top A batter (A1) would finish somewhere between B1 and B2. A2 would finish between B3 and B4, A10 between B19-20, and so on. This is done for each season. Then, find a common ‘batter’ across all seasons.

Referring now to the demographic effect, since baseball started out as predominately an all-white league, adding a non-white player increases the effective population. For example, if the White male population had doubled from 1920 to 2000, and Whites were also now only half of the league, (as determined by the above method) the 2000 effective population would be four times that of 1920, not just two times. In regard to height effect, taller players hit more homers (to a point) because generally they weigh more. Before 1920 the ball was softer; it's known as ‘The Dead Ball Era’. Players (and people) have gotten taller and the ball harder. We can take the average home runs hit by players of a certain height as an example from 1950-2000 and compare it with what that same height hit in previous years. Then plug in (taller) ‘ghost’ players to simulate what the competition should have been had players been taller in 1920 (or any dead ball era season etc.). This allows us to accurately determine how effective an earlier home run hitter (Ruth, Gehrig) really were.

As an example, if it happens that in 1920 NL the number 8 batting average (0.300) is equal As an example, if it happens that in 1920 NL the number 8 batting average (0.300) is equal (mathematically using above methods) to the number 32 batter (0.250, actually somewhere between 29-32) in 2000 AL. These are considered the same player. That would mean the same player would hit 50 points higher in 1920 NL than 2000 AL. The same player might bat 0.220 in 1968 AL. The examples provided are exemplary and do not limit the present invention as to how it may be used.

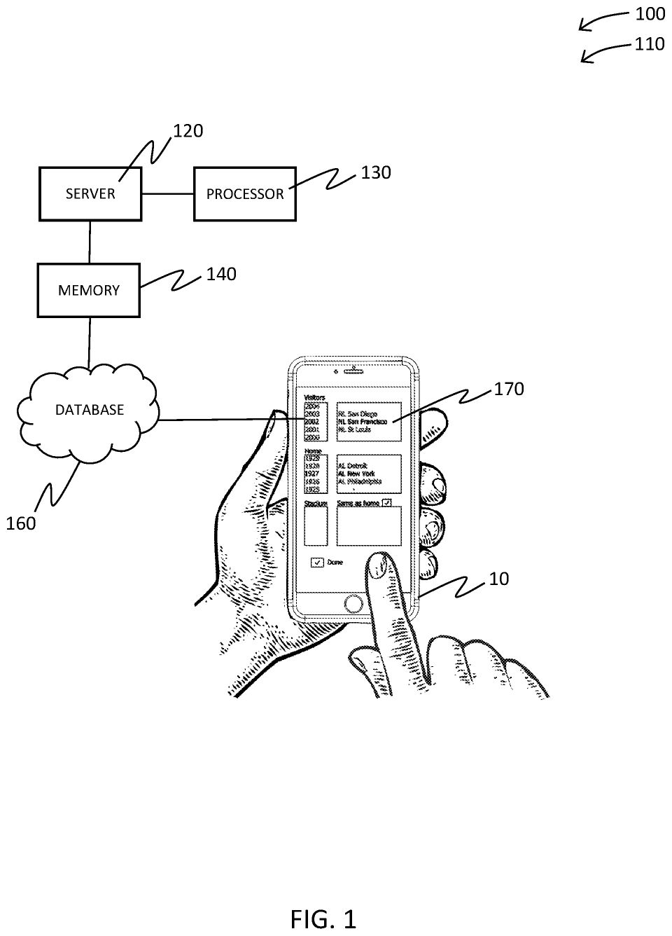

Referring now more specifically to the drawings by numerals of reference, there is shown in FIGS. 1-3, various screen views of a baseball analysis system 100 and method. As illustrated, the baseball analysis system 100 and method for facilitating access to baseball information including a software application 110 downloadable to an electronic-device 10 for calculating and analyzing statistics from a professional baseball player and team. The baseball analysis system 100 includes at least one server 120 having a processor 130 and a memory 140 including a database 160 storing a plurality of baseball-player-related-data 170. The memory 140 further includes computer readable instructions executable by the processor 130, and the software application 110 downloadable to an electronic-device 10. A user may input a request into the software application 110 and the software application 110 then determines an output 180 related to the input via the software application 110. The output 180 is displayed on the electronic-device 10 and may include useful information as related to baseball players from past to present.

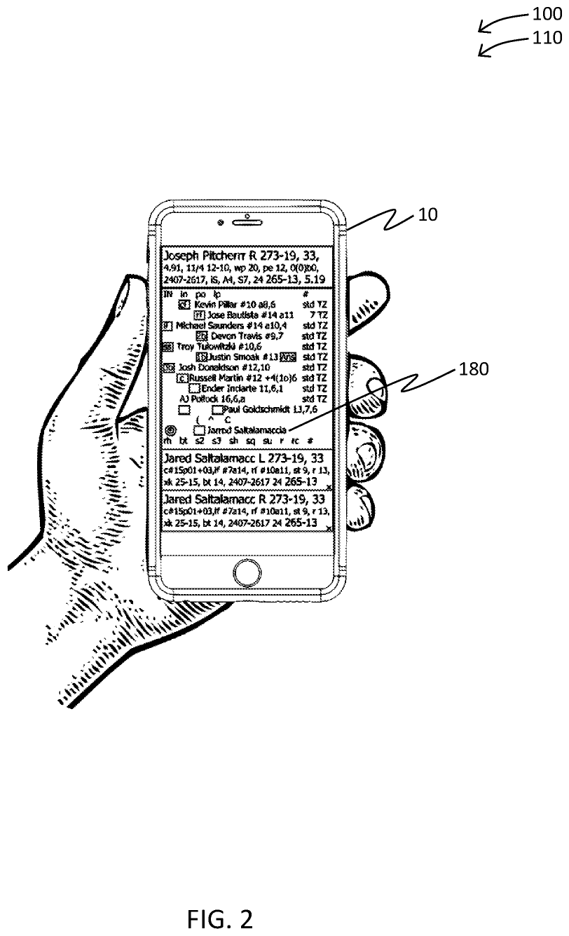

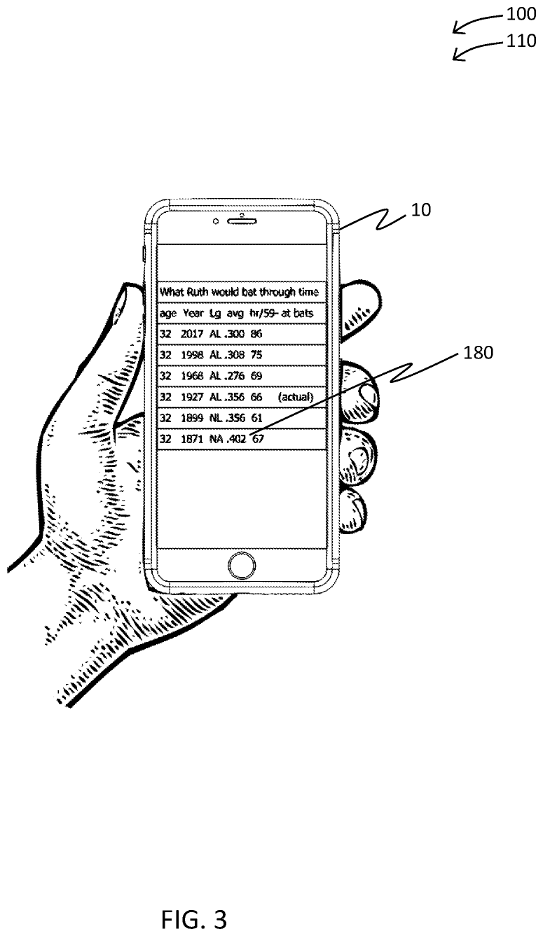

FIGS. 2-3 show additional screen views of the baseball analysis system and method 100 of FIG. 1, according to an embodiment of the present disclosure. As above, the baseball analysis system and method 100 may include the software application 110 downloadable to an electronic-device 10. The baseball analysis system 100 comprises the server 120 including the processor 130 and the memory 140 including the database 160 storing the plurality of baseball-player-related-data 170 such as runs batted in, plate appearances, and earned run average(s). The data may relate to defense or offense. A user may input various requests into the software application 110 including a trivia question and output 180 of an appropriate plurality of baseball-player-related-data 170 is the displayed on the electronic-device 10.

The baseball players are able to be selected for a fantasy team. Each of the baseball players are compared to each other statistically or statistically based upon equivalency. The equivalency takes into account rules of specific years and specific details relating to player-physical-attributes. The baseball players are able to be selected for a fantasy team and able to be played in a specific user-selected era. Each of the baseball players are compared to each other statistically ‘apples to apples’. The software application 110 may further comprise a calculator, an analyzer, and is configured to display a spinner for various uses.

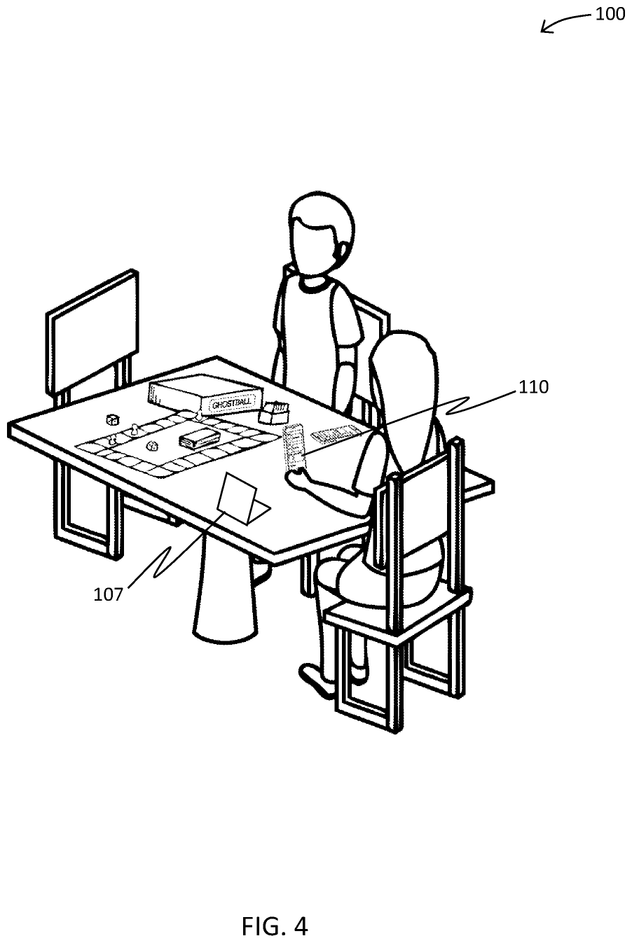

As shown in FIG. 4, the baseball analysis system and method 100 may be arranged as a kit including a set of instructions 107 and various items for playing a game using the baseball analysis system and method 100.

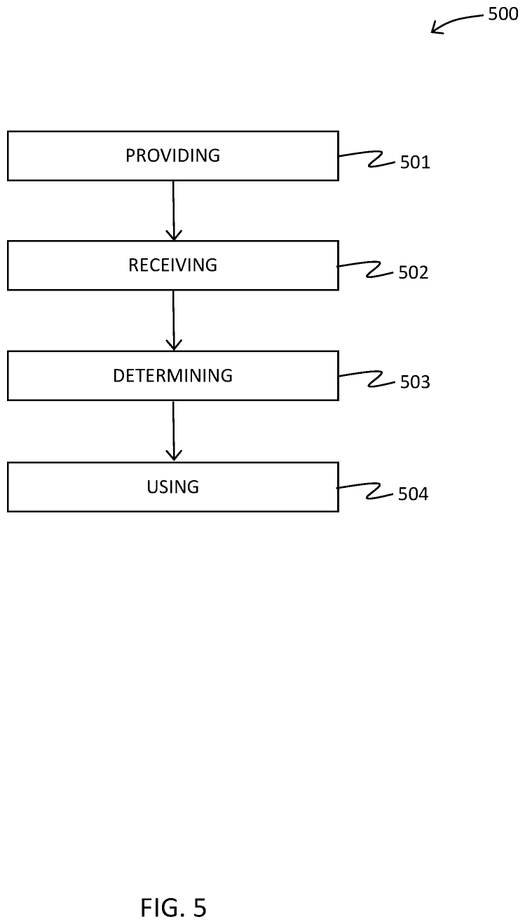

FIG. 5 is a flow diagram illustrating a method for facilitating access to baseball information 500, according to an embodiment of the present disclosure. In particular, the method for facilitating access to baseball information 500 may include one or more components or features of the baseball analysis system 100 as described above. As illustrated, the method for facilitating access to baseball information 500 may include the steps of: step one 501, providing a baseball analysis system 100 including at least one server 120 having a processor 130 and a memory 140 including a database 160 storing a plurality of baseball-player-related-data 170, the memory 140 further including computer readable instructions executable by the processor 130, and a software application 110 downloadable to an electronic-device 10; step two 502, receiving an input request from a user via the software application 110; step three 503, determining an output 180 related to the input via the software application 110 via the electronic-device 10; and step four 504, using the output 180 to generate useful information as related to baseball players from past to present.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for facilitating access to baseball information, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A baseball analysis system and method for facilitating access to baseball information, the method comprising the steps of:
providing a baseball analysis system including:
at least one server having a processor and a memory, the memory including a database storing a plurality of baseball-player-related-data, the memory further including computer readable instructions executable by the processor; and
a software application downloadable to an electronic-device;
receiving an input request from a user via the software application;
determining an output related to said input via the software application via the electronic-device; and
using the output to generate useful information as related to baseball players from past to present.

2. The method of claim 1, wherein said baseball-player-related-data comprises statistics.

3. The method of claim 2, wherein the statistics are runs batted in.

4. The method of claim 2, wherein the statistics are plate appearances.

5. The method of claim 1, wherein the statistics are earned run average(s).

6. The method of claim 1, wherein the input is related to a trivia question.

7. The method of claim 1, wherein the baseball players are able to be selected for a fantasy team.

8. The method of claim 1, wherein each of the baseball players are compared to each other statistically.

9. The method of claim 8, wherein each of the baseball players are compared to each other statistically based upon equivalency.

10. The method of claim 9, wherein the equivalency takes into account rules of specific years.

11. The method of claim 1, wherein the equivalency takes into account specific details relating to player-physical-attributes.

12. The method of claim 11, wherein the data relates to defense.

13. The method of claim 11, wherein the data relates to offense.

14. The method of claim 7, wherein the baseball players are able to be selected for a fantasy team able to be played in a specific user-selected era.

15. The method of claim 8, wherein each of the baseball players are compared to each other statistically ‘apples to apples’.

16. The method of claim 1, wherein the software application comprises a calculator.

17. The method of claim 16, wherein the software application comprises an analyzer.

18. The method of claim 1, wherein the software application is able to display a spinner.

19. A baseball analysis system and method for facilitating access to baseball information, the method comprising the steps of:
providing a baseball analysis system including:
at least one server having a processor and a memory, the memory including a database storing a plurality of baseball-player-related-data, the memory further including computer readable instructions executable by the processor; and
a software application downloadable to an electronic-device;
receiving an input request from a user via the software application;
determining an output related to said input via the software application via the electronic-device; and
using the output to generate useful information as related to baseball players from past to present
wherein said baseball-player-related-data comprises statistics, said statistics comprising historical-statistical-data;
wherein the statistics are runs batted in, plate appearances, earned run average(s);
wherein the input is related to a trivia question;
wherein the baseball players are able to be selected for a fantasy team;
wherein each of the baseball players are compared to each other statistically;
wherein each of the baseball players are compared to each other statistically based upon equivalency;
wherein the equivalency takes into account rules of specific years;
wherein the equivalency takes into account specific details relating to player-physical-attributes;
wherein the data relates to defense;
wherein the data relates to offense;
wherein the baseball players are able to be selected for a fantasy team able to be played in a specific user-selected era;
wherein each of the baseball players are compared to each other statistically ‘apples to apples’;
wherein the software application comprises a calculator;
wherein the software application comprises an analyzer; and
wherein the software application is able to display a spinner.

20. A baseball analysis system of claim 19, further comprising a set of instructions; and
wherein said baseball analysis system is arranged as a kit.
